(19) United States
(12) Patent Application Publication
(10) Pub. No.: US 2005/0108172 A1
(43) Pub. Date: May 19, 2005

(54) Detecting and reporting infringement of an intellectual property item

(76) Inventor: Robert Jacob Pet, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/505,500

(22) PCT Filed: Feb. 3, 2003
(86) PCT No.: PCT/IB03/00431

(30) Foreign Application Priority Data
Feb. 27, 2002 (EP) 02075770.4

(51) Int. Cl. G06F 17/60; H04K 1/00

(52) U.S. Cl. 705/57

(57) ABSTRACT

A method and a system of/for detecting and reporting infringement of an intellectual property item on a client server system. The intellectual property item can be a utility model, a patent, a trademark, a design or a copyright. The method includes the steps of transferring a first information item (1004) representing an intellectual property item based on a selection criterion from a server (1001) to a client (1003); transferring a second information item (1005) representing a potentially infringing object specified by a user (1006) from the client to the server or transferring by mail the second information item to an administrator of the intellectual property item. The method further includes the steps of involving the user in the detection and the reporting of infringement by a simulation in the form of a presented good will of justice and a presented potential reward in order to make the user transfer the second information item, and presenting a reward when infringement is in fact determined. The potentially infringing object can be a product, a method, a text, a figure, a sales article and combinations thereof.

This invention relates to a method of detecting and reporting infringement of an intellectual property item on a client server system.

The present invention also relates to a computer system for performing the method.

The present invention further relates to a computer program product for performing the method.

The present invention further relates to a system for detecting and reporting infringement of an intellectual property item on a client server system.

On the Web site www.bountyquest.com of Dec. 19, 2001 14:20 a so-called BountyQuest is disclosed. It is an Internet Web site where companies post rewards for documents that describe certain information, and where users may provide the corresponding document(s) to collect the rewards. Companies can contact the Web site when they need an important document, such as a document that may prove whether a patented invention is really novel or not. The web site is contacted by the companies, when they think users of the Internet know where to find such a document. The document could be any kind of public information, such as a part of a book, an academic thesis or paper, or a newspaper or an article in a magazine. If the users can help, i.e. provide the site with information (document) making sense when a so-called invalidation of a patent is discussed, they may win an amount of cash: a so-called Bounty. The Companies inform the site of the amount of cash they are willing to pay for a useful document. The inventions, so-called Bounties; are sorted in categories to help users determine in which area they believe they can find information with respect to a given invention. If a user finds the right document, the user will submit it to the Web site, and, after verifying that it is the right document, the site will pay the user a reward. On the site, there are rules for submitting documents. The sites take a fee (from companies) that allows them to provide this service, the user of the sites does not have to pay. The Web site www.bountyquest.com is directed to invalidation of an existing patent by a party that is adversely affected by it, and this is done by searching for information with respect to disclosures/uses of the subject matter of existing patent before the priority date of the patent to be invalidated.

However, the above prior art method involves only the problem of invalidating a granted patent, whereas the infringement of a patent or the infringement of any other established intellectual property right is not considered by the prior art.

An object of the present invention is therefore to get ordinary people into the process of detecting infringement, i.e. the use of a patented invention or the unlawful use of an intellectual property right of a person or a company after the grant of the patent for the said invention or after the establishment of an intellectual property right. To the public, patent databases maintained by patent authorities and other databases for intellectual property rights, are mostly unknown and they are mainly accessible by the employees working there. Furthermore, private companies also provide patent databases and databases for other intellectual property rights, but they are primarily accessible upon a payment of a relative high fee. However, in recent years some of theses databases have become available to the public. A problem with these databases with respect to the search of patents is that if people who are trying to find out whether a patented invention is infringed are not aware of certain terms, such as the International Patent Classification (IPC) system subdivided into an ECLA classification known from Europe or the US class system known from USA and the like from Japan, and/or particular keywords, it is most likely that an existing infringed patented invention is not found, because to people who are not skilled or experienced users, the patent databases are very hard to use; and similar problems exist when other intellectual property rights are to be searched. In other words, generally, it cannot be expected that the public can readily become acquainted or can be readily become aware of a granted patent or other established intellectual property right and then subsequently recognize that the granted patent or the established intellectual property right is actually being infringed by something sold or used.

Normally, the mentioned private databases or the databases from patent authorities will be searched for patents and other intellectual property rights by people, typically engineers, skilled in the use of so-called search terms and/or of using particular keywords with corresponding synonyms. This search is time-consuming and rather expensive. In other words, the problem is that when large patent portfolios or other portfolios of intellectual property rights of companies have to be monitored frequently or to be searched for infringement from competing products, trademarks, names etc, this searching and monitoring involve tremendous efforts with respect to costs and the amount of people involved in such search that is to be performed continuously, completely and with a high hit rate. The monitoring has to be carried out from two sides, on the one hand to select patents or intellectual property rights in the corresponding database and on the other hand in the real word of possible infringing products, processes, trademarks, names, etc. for the correspondingly selected intellectual property right. The monitoring in the real world may be done by searching at exhibitions, trade-fairs or by examining company catalogues or checking Internet-sites that promote various services, products, processes for sale, etc.

The object is achieved by a method of detecting and reporting infringement of an intellectual property item on a client server system, the method comprising the steps of
transferring a first information item representing an intellectual property item based on a selection criterion from a server to a client; and
transferring a second information item representing a potentially infringing object specified by a user from the client to the server, or transferring by mail the second information item to an administrator of the intellectual property item;
   In the first step, the intellectual property item is selected and made available to the public to determine a possible infringement of it.

Hereby the problem of monitoring large patent portfolios or other portfolios of intellectual property rights of companies is solved in the first step.

In the second step, the potentially infringing object is reported back by means of the Internet or by means of a postal service.

The advantage is that large patent portfolios or other portfolios of intellectual property is hereby monitored and then searched in real life for infringement from competing products, trademarks, names etc, This monitoring and searching are conducted at low costs and without the employing of much manpower do so, further the search and monitoring can be carried out continuously.

Further, the object to involving ordinary people in the process of detecting infringement is achieved by the said two steps.

Another embodiment of the method is described in claim 2.

Hereby a further object of providing an incentive—i.e. as a consequence of said stimulation (which will be explained later)—to people to supervise or monitor a particular patent or a particular intellectual property right for infringement is also achieved.

Another embodiment of the method is described in claim 3.

In other words, in these three sub-steps, the method—when executed—may first present a list of patents or a list of other intellectual property rights to the user sitting at the client site. The list may comprise what companies desire, i.e. intellectual property item(s) to be monitored with respect to possible infringements. The user may at the client site have selected a particular category to make the list reflect his interests, i.e. what (potentially infringing object) the user believes is most likely to be found to infringe the selected intellectual property item(s).

Secondly, upon the selected intellectual property item(s), a link or links to these with corresponding description(s) is made on the server.

Thirdly, the corresponding description(s) of the selected intellectual property item(s) is/are transferred and then presented to the client to the user.

Hereby a further object is achieved of providing a readily accessible disclosure or presentation of patents or any other intellectual property right that a company desires to have supervised for infringement by ordinary people.

Another embodiment of the method is described in claim 4.

Hereby, as a possible response to the description of selected intellectual property items, the user may firstly enter a potentially infringing object on the client site with a textual description of it, optionally also with drawings and photos of the potentially infringing object and with information about when and where the object was found. Secondly, the user may enter name, address, and e-mail to identify himself. Thirdly, the information from these two steps is sent to the server.

Another embodiment of the method is described in claim 5.

Hereby a further object of providing an incentive, i.e. the good will of justice and the reward, to people to supervise or monitor a particular patent or a particular intellectual property right for infringement is also achieved.

By involving third parties, i.e. user of the said method, in this monitoring the capacity for monitoring is increased tremendously. Hence, a more effective and more complete monitoring of the patent portfolio and other intellectual property rights portfolio is achieved.

Another embodiment of the method is described in claim 6.

By these first three steps, it is verified that if no licence exists, and if the intellectual property item is protected against the potentially infringing object, and if it is for the first time known that something (the infringing object) reported by the user infringes the intellectual property item, the reward may subsequently be granted to the user in the final step.

Other embodiments of the invention are described in claims 7 and 8.

The object is further achieved by a system for detecting and reporting infringement of an intellectual property item on a client and a server, the system comprising:
means for transferring a first information item representing an intellectual property item based on a selection criterion from the server to the client; and
means for transferring a second information item representing a potentially infringing object specified by a user from the client to the server, or transferring by mail the second information item to an administrator of the intellectual property item;
   Embodiments of the system are described in claims 10 to 14.

The system gives the same advantages for the same reasons as described previously in relation to the method.

Further, the system achieves the same further objects as the method.

The invention will be explained more fully below in connection with preferred embodiments and with reference to the drawings, in which:

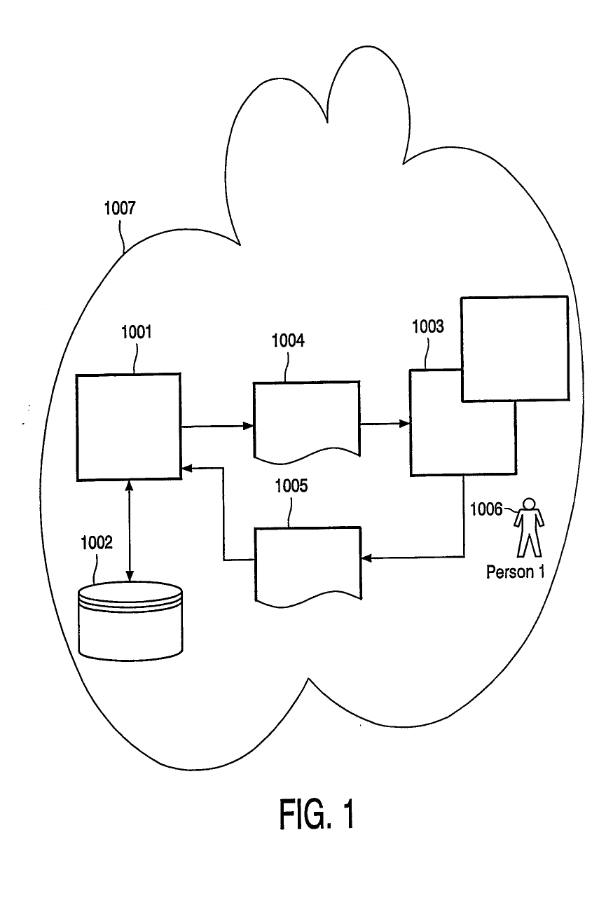

FIG. 1 illustrates a system with a server, clients, a user and the flow of information,

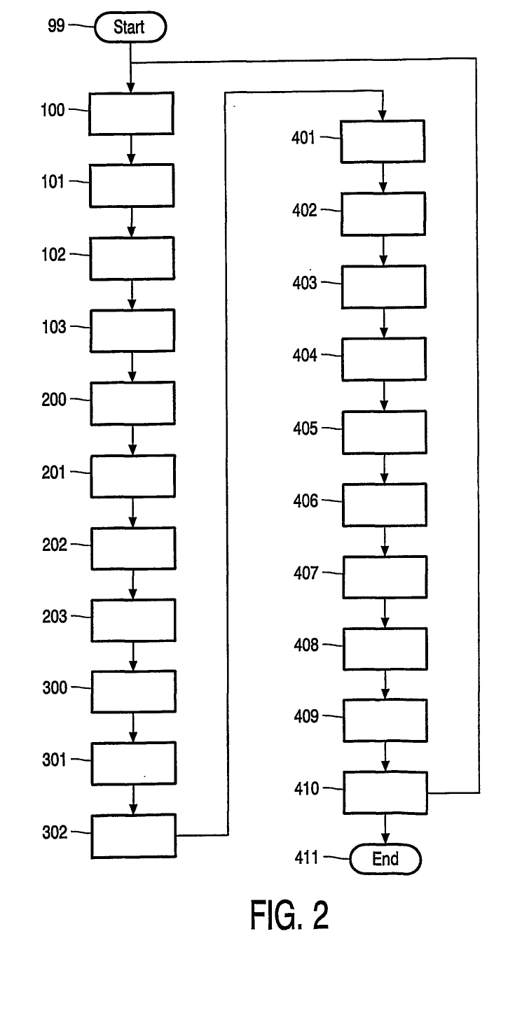

FIG. 2 illustrates a method of detecting and reporting infringement of an intellectual property item to a client server system with a user reporting possible infringement,

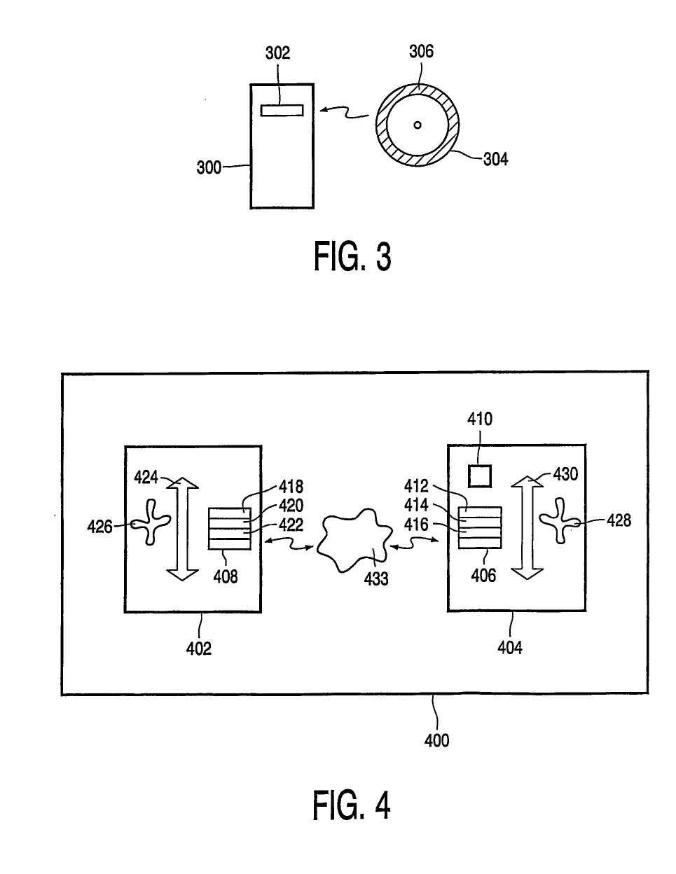

FIG. 3 illustrates an embodiment of a computer system,

FIG. 4 illustrates an embodiment of a system according to the invention in a schematic way.

FIG. 1 shows a system with a server, clients, a user and the flow of information.

In a preferred embodiment of the invention, the method of the invention (FIG. 2) is executed on a client server system.

Reference numeral 1001 may be a server. The server is mainly the controlling part of the system. The server may be accessed by various clients as shown by reference numeral 1003. The server comprises means for connection to the Internet with a possibility to be accessed simultaneously by various clients using the service of the Website, which is provided by the method of FIG. 2.

The server may have a connection to a database, which is shown by reference numeral 1002. The database may comprise various intellectual property items, such as information about utility models, patents, trademarks and/or copyright. When one of these items is selected on the client, the server may provide the corresponding information in the form of a textual description, a drawing and or a photo to be presented on the client.

Reference numeral 1003 may be the client. The client may be used as the connection point to a user, reference numeral 1006, using the method of FIG. 2. There may be more clients simultaneously accessing the server via the Internet or any other open network, reference numeral 1007. The various clients are designated by the two rectangles of reference numeral 1003.

Reference numeral 1004 may generally represent information of the method sent from the server to the client by means of reference numeral 1007. The said information may comprise information about intellectual property items that may have been selected on the basis of a number of intellectual property items presented on the client after retrieval from the server based on a user choice. The intellectual property items may be a list of patents and or a list of other intellectual property items with title, abstract and or optionally drawings and or photos that one or more companies wish to have monitored with respect to possible infringement(s). The user may select the intellectual property items for which he believes that it is possible for him to find an infringing object. Upon the user choice of a given intellectual property item, reference numeral 1004 may further comprise a comprehensive description in the form of a text, a picture and or a drawing in known downloadable file format. The information may further comprise the company's name, address and e-mail for each company having the ownership of the property items, and additionally said information may further comprise a confidentiality agreement issued by the owner of the property items.

The reference numeral 1005 may generally be information sent in the opposite direction of the method as a response to the information contained in reference numeral 1004. The information is sent from the client to the server also by means of reference numeral 1007. The said information may be in a textual form describing a potentially infringing object. The information of the potentially infringing object may be described in the form of a text, a picture, a photo and or a drawing in a known downloadable file format. The potentially infringing object may be any item, which in some way may infringe the information contained in reference numeral 1004. The information of reference numeral 1005 may further comprise the user's name, address, e-mail and or bank account. When the user accepts said confidentiality agreement, the said information may further comprise a typed in authorization code.

Reference numeral 1006 may be the user at the client site. The user may have browsed to the website implementing the method of the present invention, in that the user desires to win a reward when he reports—in the form of the said potentially infringing object—any infringement of any legally protected intellectual property item presented on the web page.

Reference numeral 1007 may be an open network. The network may be the Internet or any other hard- or non hard-wired connection known to enable communication between clients and a server.

FIG. 2 shows a method of detecting and reporting infringement of an intellectual property item on a client server system with a user reporting possible infringement in another preferred embodiment of the invention.

In step 99, the method is started. Variables, flags, buffers, etc., keeping track of authorization codes, received and sent first information items representing any previous intellectual property items are set to default states on the server, and when any client accesses the client, i.e. the client tries to access the Web page from which the present invention is initiated and running, a similar action will be performed on the client. Correspondingly, second information items representing any previous typed-in potentially infringing objects are set to have no data on the client and the server, when the method is started in this step. Further a register or a database on the server having information about rewards to be computed, already computed, etc. are initialised or set to proper values. When the method is started a second time, only corrupted variables, flags, buffers, registers, etc. are reset to default values.

In step 100, a first information item representing an intellectual property item based on a selection criterion may be transferred from a server to a client. Step 100 constitutes a generalisation of steps 101, 102 and 103.

In step 101, the first information item may be selected based on a number of intellectual property items on the server. On the Web site presented on the client a list of patents or a list of other intellectual property items with title and optionally with a brief abstract and particular drawings that one or more companies wish to have monitored with respect to possible infringements may be presented. The user at the client site may have various categories presented, e.g. in the world of computers it may be the categories of software, e-commerce, electronics, Internet, semiconductors, telecom, hardware, software, etc. Naturally, the user wishing to avail himself of the said method will choose a category where he or she is most likely to know the technical area or where he or she believes that it is possible to find an infringing object that is most likely to infringe the said intellectual property item. The intellectual property item comprises at least one of a utility model, a patent, a trademark, a design and a copyright. The infringing object may correspondingly comprise a product, a method, a text, a figure, a sales article and/or any combination thereof. E.g. a sold product may infringe several intellectual property rights in that the intellectual property item may already be protected in several ways, it may be patented for technical reasons or it may be protected by means of a utility model protection, having a known, protected trademark, etc.

In step 102, a description of the first information item on the server may be linked to. Upon the user choice of a given intellectual property item, it may be possible by means of a link, an URL etc, to get a more detailed description of the first information item that may represent said intellectual property item.

In step 103, the description of the first information item on the client may be presented. From the foregoing step, the content of the link may be shown on the Web site or downloaded to a file for later viewing on the client site.

In step 200, a second information item representing a potentially infringing object specified by a user may be transferred from the client to the server, or the second information item may be transferred by mail to an administrator of the intellectual property item. Step 200 constitutes a generalisation of steps 201, 202 and 203.

Instead of a transferring the potentially infringing object from the client to the server by means of the Internet, said object may be transferring by post to an administrator of the intellectual property item. It may be more convenient to use the postal service to send the infringing object such as bought product as a physical proof of an infringement. The administrator of the intellectual property item may be the owner himself, or the administrator may be somebody, i.e. a lawyer, a patent attorney etc., taking care of the owners interests.

In step 201, the second information item may be entered in a textual form, by a photo, by a drawing or by combinations thereof that describes the potentially infringing object with information about where and when the object was detected to the client. The second information item may be any item, that, at this stage of the process, the user may think in some way can infringe the said first information item. With the information from the steps 100 through 103, the user may look for any product that he believes to constitute an infringement of said property right or rights of said intellectual property item. Further information about where and when the possible infringing object was found may be entered along with the description of the potentially infringing object; it may be in the form of a textual description or by means of an attached photo, a drawing or a file in any appropriate format.

In step 202, various information may be entered by the user in order to identify the user. The information may be the user's name, address, and e-mail, that are entered on the client on the chosen Web site. Naturally, in this step, the user desires to identify himself by means of his or her name, address, e-mail and may be also his or her account in a bank for a possible transfer of the reward, if later granted.

In step 203, said information may be send jointly to the server. In this step the information collected on the client from the user from the two foregoing step is send to the server.

In step 300, the user may be involved in the detection and the reporting of infringement by a stimulation of the user to transfer the second information item. Step 300 constitutes a generalisation of steps 301 and 302.

In step 301, a good will of justice may be called up in a presentation on the client. In order to stimulate the user to report an infringement—which the user at this point considers possible—the Web site presented on the client, may, when this method is executed—inform the user how infringement is defined, and the consequently explaining why it is non-ethical to infringe others intellectual property rights and thereby calling up the good will of justice.

In step 302, a potential reward may be presented to the client. Said reward may be presented to the client, even though infringement is not determined on the server at this point. The reward is also used to stimulate the user to report an infringement. It is important that the potential reward is presented on the Web site on the client with an explanation that the conditions of the coming steps must be satisfied in order to receive the reward.

In step 401, it may be verified that the potentially infringing object does not have a licence based on the intellectual property item. As a first criterion known from most law with respect to intellectual property, it is here checked that the possible infringing object is not already licensed, i.e. that an intellectual right or agreement has already been made, whereby said possible infringing object can not infringe the property right from step 100.

In step 402, it may be verified that the intellectual property item is actually protected against the potentially infringing object. As a second criterion known from most law with respect to intellectual property, it is here checked that the intellectual property item has a protection that covers the use, the making, etc of the possible infringing object, i.e. an intellectual right is already granted and covers the infringing object, whereby the infringing object can actually by law be said to infringe the property right.

In step 403, it may be verified that the potentially infringing object is not already known to infringe the intellectual property item. It may be the case that someone else already reported an infringement, in such a situation there is no basis for a reward. On the contrary, the first person to report the infringement has the right to the reward of step 410.

Said steps 401 through 403 may be performed by a very intelligent computer on the server site, optionally with help from a person with knowledge of how to manage intellectual property rights.

In step 404, a confidentiality agreement may be presented to the user of the web site. The agreement may then be accepted by an authorization code, this in combination forms the basis and the acceptance for the further reporting of infringing information on the client Web site (by the user) to the server (to the company). As information with respect to intellectual property by the nature often is considered to be confidential with respect to licenses and agreements, etc., the company presenting intellectual property items may demand that some kind of confidentiality be established and agreed between the user and said company.

In step 405, the client enables the user to enter the authorization code for accessing confidential information on the intellectual property items on the client. Here, after reading the confidentiality agreement, the user may choose to enter the authorization code as a confirmation of agreement; if the user finds that the agreement is too binding or unfair, he or she may choose to stop at this point.

In step 406, a list of companies and sales articles are presented. The list comprises companies and sales articles known to infringe the intellectual property item. The list is only presented to the user, if the authorization code that was given in the foregoing step is accepted by the software on the server.

In step 407, a list of companies is presented to the client. The list comprises person(s), companies, etc, to which a licence is granted on the intellectual property item. The list is only presented to the user, if the authorization code given in step 405 was accepted by the software on the server.

In step 408, name, address, and e-mail for the owner of intellectual property item may be retrieved from the server by the client to be presented on the client. The user is here informed about the owner of the intellectual property item by means of the said information.

In step 409, conditions may be presented subject to which a reward will be given to the user on the client when the intellectual property item legally may be determined to be infringed by the infringing object. The conditions for giving a reward may be that no licences exist, the intellectual property item is actually legally protected against the potentially infringing object, and it is for the first time reported that the infringing object may infringe the intellectual property item. A further condition may be secrecy between the user and the company.

In step 410, on the client, a reward is presented when infringement is determined. If the condition from the steps 401 through 403 are satisfied; i.e if no licence exists at this point, the intellectual property item is protected against the potentially infringing object, and when it is for the first time known that something (the infringing object) reported by the user infringes the intellectual property item, the reward may presented and granted to the user.

Usually, the method will start all over for beginning again as long as the client server system of FIG. 1 (where the method is implemented and executed) is powered and is properly exchanging said information of reference numeral 1004 and 1005. Otherwise, the method may terminate in step 411; however, when the system of the client and the server is powered again, the method may proceed from step 100 again.

A computer readable medium may be magnetic tape, optical disc, digital video disk (DVD), compact disc (CD record-able or CD write-able), mini-disc, hard disk, floppy disk, smart card, PCMCIA card, etc.

FIG. 3 illustrates a general purpose computer 300 that comprises a compact disk reader 302. The computer 300 can comprise computer readable code such that it acts as a server, that is designed to perform the server capabilities of the method according to the invention. It can also comprise computer readable code that is designed to perform the client capabilities of the method according to the invention as previously described. The computer readable code can be downloaded at the computer 300 via a compact disk 304 that comprises the computer readable code 306. It can also be downloaded through the internet, or any other medium.

FIG. 4 illustrates the main parts of the system 400 according to the invention in a schematic way. Here, a client system 402 and a server system 404 are connected to each other via the internet 433. The server system 404 comprises a software bus 430, a central processing unit 428 (CPU) and general purpose memories. The general purpose memories comprise computer readable code 406, 412, 414, 416 and 410. The computer readable code 406 is designed to transfer a first information item representing an intellectual property item based on a selection or criterion from the server 404 to the client 402. The computer readable code 412 is designed to select the first information item based on a number of intellectual property items on the server. The computer readable code 414 is designed to link a description of the first information item on the server. The computer readable code 416 is designed to present the description of the first information item to the client. The computer readable code 410 is designed to involve the user in the detection and the reporting of infringement by a stimulation of the user to transfer the second information item.

Communication between the memories and the CPU is performed via software bus 430. The client system 402 comprises also a software bus 424, a central processing unit 426 (CPU) and general purpose memories. These general purpose memories comprise computer readable code 418, 420, 422 and 408. The computer readable code 408 is designed to transfer a second information item representing a potentially infringing object specified by a user from the client to the server, or transferring by mail the second information item to an administrator or the intellectual property item. The computer readable code 418 is designed to enter the second information item in a textual form, by a photo, by a drawing or by combinations thereof that describes the potentially infringing object with information about where and when the object was detected to the client. The computer readable code 420 is designed to enter information about the user name, address, and e-mail on the client. The computer readable code 422 is designed to send said information jointly to the server. The memories and CPU communicate with each other through software bus 424. This system 400 further comprises memories that can comprise computer readable software that is designed to perform the steps of the method according to the invention as previously described.

1. A method of detecting and reporting infringement of an intellectual property item on a client server system, the method comprising the steps of:
transferring (100) a first information item (1004) representing an intellectual property item based on a selection criterion from a server (1001) to a client (1003); and
transferring (200) a second information item (1005) representing a potentially infringing object specified by a user (1006) from the client to the server, or transferring the second information item to an administrator of the intellectual property item.

2. A method according to claim 1, characterized in that the method further comprises the step of:
involving (300) the user in the detection and the reporting of infringement by a stimulation of the user to transfer the second information item.

3. A method according to claim 1, characterized in that the step of transferring the first information item comprises the sub-steps of:
selecting (101) the first information item based on a number of intellectual property items on the server;
linking (102) to a description of the first information item on the server; and
presenting (103) the description of the first information item to the client.

4. A method according to claim 1, characterized in that the step of transferring the second information item comprises the sub-steps of:
entering (201) the second information item in a textual form, by a photo, by a drawing or by combinations thereof that describes the potentially infringing object with information about where and when the object was detected to the client;
entering (202) information about the user name, address, and e-mail on the client; and
sending (203) said information jointly to the server.

5. A method according to claim 1, characterized in that the step of involving the user in the detection and the reporting of infringement by a stimulation of the user to transfer the second information item comprises the sub-steps of:
calling up (301) a good will of justice in a presentation on the client; and
presenting (302) a potential reward to the client.

6. A method according to claim 1, characterized in that the method further comprises the steps of:
verifying (401) that the potentially infringing object does not have a licence based on the intellectual property item;
verifying (402) that the intellectual property item is protected against the potentially infringing object;
verifying (403) that the potentially infringing object is not already known to infringe the intellectual property item; and
presenting (404) a confidentiality agreement to be accepted by an authorization code for detecting and reporting infringing information to the client;
enabling (405) the user to enter the authorization code for accessing confidential information on the intellectual property items on the client;
presenting (406) a list of companies and sales articles that are known to infringe the intellectual property item, if the authorization code is accepted;
presenting (407) a list of companies to which a licence is granted on the intellectual property item on the client, if the authorization code was accepted;
retrieving (408) name, address, and e-mail for the owner of the intellectual property item from the server to the client;
presenting (409) conditions subject to which a reward will be given to the user on the client when the intellectual property item can be determined to be infringed by the infringing object; and
presenting (410), on the client, a reward when infringement is determined.

7. A method according to claim 1, characterized in that the intellectual property item comprises at least one of a utility model, a patent, a trademark, a design and a copyright.

8. A method according to claim 1, characterized in that the infringing object comprises at least one of a product, a method, a text, a figure, a sales article and combinations thereof.

9. A computer system (300) for performing the method according to claim 1.

10. A computer program product comprising program code means (306) stored on a computer-readable medium (304) for performing the method of claim 1 when the computer program is run on a computer (300).

11. A system (400) for detecting and reporting infringement of an intellectual property item on a client (402) and a server (404), the system (400) comprising:
means (406) for transferring a first information item representing an intellectual property item based on a selection criterion from the server (404) to the client (402); and
means (408) for transferring a second information item representing a potentially infringing object specified by a user from the client (402) to the server (404), or transferring by mail the second information item to an administrator of the intellectual property item.

12. A system (400) according to claim 11, characterized in that the system further comprises:
means (410) for involving the user in the detection and the reporting of infringement by a stimulation of the user to transfer the second information item.

13. A system (400) according to claim 11, characterized in that the means (406) for transferring the first information item comprises:
means (412) for selecting the first information item based on a number of intellectual property items on the server;
means (414) for linking to a description of the first information item on the server; and
means (416) for presenting the description of the first information item to the client.

14. A system (400) according to claim 11, characterized in that the means (408) for transferring the second information item comprises:
means (418) for entering the second information item in a textual form, by a photo, by a drawing or by combinations thereof that describes the potentially infringing object with information about where and when the object was detected to the client;
means (420) for entering information about the user name, address, and e-mail on the client; and
means (422) for sending said information jointly to the server.
